(19) United States
(12) Patent Application Publication
(10) Pub. No.: US 2012/0229711 A1
(43) Pub. Date: Sep. 13, 2012

(54) ILLUMINATING DEVICE, DISPLAY DEVICE, AND TELEVISION RECEIVER

(75) Inventor: Yoshiki Takata, Osaka (JP)

(73) Assignee: Sharp Kabushiki I Kaisha, Osaka (JP)

(21) Appl. No.: 13/508,914

(22) PCT Filed: Oct. 22, 2010
(86) PCT No.: PCT/JP2010/068696

§ 371 Date: May 17, 2012

(30) Foreign Application Priority Data
Nov. 10, 2009 (JP) 2009-256995

(51) Int. Cl. G09F 13/04; G02F 1/13357; H04N 3/14

(52) U.S. Cl. 348/790; 362/97.1; 349/61; 348/E05.133

(57) ABSTRACT

The present invention has an object to reduce the manufacturing cost of a power supply substrate connected to a discharge tube in an illuminating device by reducing the size of the power supply substrate. The illuminating device 2 according to the present invention includes a chassis 4, discharge tubes 20 which have electrodes 17 at respective end portions of glass tubes 18 and in which the glass tubes 18 are bent such that these electrodes 17 are disposed in one direction, and a power supply substrate which supplies power to the discharge tubes 20. Two discharge tubes 20 are disposed inside the chassis 4. The discharge tubes 20 are housed side by side inside the chassis 4 such that the respective electrodes of the two discharge tubes 20 are lined up in one direction when the chassis 4 is seen in a plan view. Among the electrodes 17 that are lined up in one direction, the two electrodes 17 positioned on the inner side are electrically connected to the power supply substrate, while the two electrodes 17 positioned on the outer side are electrically connected to the chassis 4.

### TECHNICAL FIELD

The present invention relates to an illuminating device, a display device, and a television receiver.

### BACKGROUND ART

A backlight device arranged with two discharge tubes (U-shaped tubes) which have electrodes at both end portions of tubular bodies and in which the tubular bodies are bent such that these electrodes are disposed in one direction is known as the backlight device used in a display device. In general, in such a backlight device, power supply substrates are respectively electrically connected to the two discharge tubes, and power is supplied to the discharge tubes from these power supply substrates. Consequently, the discharge tubes are lit.

Patent Document 1 discloses a backlight device including two U-shaped cold cathode tubes having electrodes at both end portions thereof and a power supply substrate for supplying power to these two cold cathode tubes. In this backlight device, the discharge tubes are disposed side by side such that the respective electrodes of the two cold cathode tubes are lined up in one direction.

### RELATED ART DOCUMENTS

### Patent Documents

Patent Document 1: Japanese Patent Application Laid-Open Publication No. 2008-262817

### Problems to be Solved by the Invention

In the backlight device of Patent Document 1, a single power supply substrate is connected to the respective electrodes lined up in one direction. Therefore, in cases where these two discharge tubes are housed inside a chassis and this power supply substrate is disposed on the back surface of the chassis, the area occupied by the power supply substrate ends up extending in a wide range with respect to the chassis. When the surface area of the power supply substrate becomes large, the manufacturing cost of the power supply substrate is inevitably increased.

### SUMMARY OF THE INVENTION

The present invention was created in light of the aforementioned problem. The present invention has an object to provide technology whereby, in an illuminating device arranged with two discharge tubes which have electrodes at both end portions of tubular bodies and in which the tubular bodies are bent such that these electrodes are disposed in one direction, the manufacturing cost of a power supply substrate connected to the discharge tubes can be reduced by reducing the size of the power supply substrate. The present invention also has an object to provide a display device equipped with such an illuminating device and a television receiver equipped with such a display device.

### Means for Solving the Problems

The technology disclosed in the present specification relates to an illuminating device that includes a chassis, a discharge tube having electrodes at both end portions of a tubular body, the tubular body being bent such that the electrodes are disposed in one direction, and a power supply substrate that supplies power to the discharge tube, wherein two of the discharge tubes are disposed inside the chassis, the discharge tubes are housed side by side inside the chassis such that the respective electrodes of the two discharge tubes are lined up in one direction when the chassis is seen in a plan view, and among the electrodes lined up in the one direction, the two electrodes positioned on an inner side are electrically connected to the power supply substrate, while the two electrodes positioned on an outer side are electrically connected to the chassis.

With the aforementioned illuminating device, the power supply substrate is not connected to the two electrodes positioned on the outer side, and the power supply substrate is connected only to the two electrodes positioned on the inner side. By disposing the power supply substrate only in the vicinity of the two electrodes positioned on the inner side, the size of the power supply substrate can be reduced. Consequently, the manufacturing cost of the power supply substrate can be reduced.

In the aforementioned illuminating device, the power supply substrate may be disposed between the two electrodes positioned on the outer side when the chassis is seen in a plan view. With this configuration, a power supply substrate that is further reduced in size can be realized.

In the aforementioned illuminating device, one adjustment circuit may be further provided, and the two electrodes positioned on the inner side may be electrically connected to the adjustment circuit. With this configuration, by disposing the adjustment circuit only in the vicinity of the two electrodes positioned on the inner side, the size of the adjustment circuit can be reduced. Consequently, the manufacturing cost of the adjustment circuit can be reduced.

The aforementioned adjustment circuit may be built into the power supply substrate. With this configuration, the adjustment circuit can be manufactured in the same step as the power supply substrate, so the manufacturing steps of the illuminating device can be simplified.

In the aforementioned illuminating device, alternating-current voltages of the same phase may be applied to the two electrodes positioned on the inner side. With this configuration, as a result of the alternating-current voltages applied to the two electrodes positioned on the inner side being of the same phase, reliability of the illuminating device such as voltage resistance is improved.

In the aforementioned illuminating device, alternating-current voltages of opposite phases may be applied to the two electrodes positioned on the inner side. With this configuration, as a result of the alternating-current voltages applied to the two electrodes positioned on the inner side being of opposite phases, electromagnetic noise generated on the front surface side of the illuminating device is cancelled. Consequently, the effect of the electromagnetic noise can be suppressed.

In the aforementioned illuminating device, relay connectors attached to the chassis may be further provided, and the electrodes may be electrically connected to the power supply substrate via the relay connectors. With this configuration, the discharge tubes and the power supply substrate can be connected directly without using lead wiring.

In the aforementioned illuminating device, each of the discharge tubes may have outer leads which are formed so as to protrude from the respective end portions of the tubular body and which are used to receive the supply of power from the power supply substrate, and caps each including a main body attached to the outer circumference of the tubular body and a connecting part electrically connected to the power supply substrate and a conductive piece which extends from the main body and is connected to the corresponding one of the outer leads. The caps may constitute the electrodes, and the relay connectors may have cap housing parts that house the caps. With this configuration, as a result of the caps being housed in the cap housing parts, the discharge tubes and the relay connectors can be connected in a simple manner.

In the aforementioned illuminating device, the relay connectors may have insertion opening parts that permit the insertion of the power supply substrate, the power supply substrate may have, at an end portion, mating parts that mate with the insertion opening parts, and the relay connectors and the power supply substrate may be electrically connected. With this configuration, as a result of the mating of the insertion opening parts and the mating parts, it is possible to realize the card edge-type connection between the relay connectors and the power supply substrate. Therefore, the relay connectors and the power supply substrate can be connected directly without using lead wiring.

In the aforementioned illuminating device, the mating parts may have recessed parts that sandwich the insertion opening parts. With this configuration, the card edge-type connection can be simplified between the relay connectors and the power supply substrate.

In the aforementioned illuminating device, each of the relay connectors may include an insulating holder attached to the chassis and a relay terminal which can be electrically connected to the power supply substrate and one of the discharge tubes and which is attached to the holder. With this configuration, it is possible to prevent current flowing through the relay connector from short-circuiting by use of the holder while ensuring the electrical continuity between the power supply substrate and the discharge tube using the relay terminal.

In the aforementioned illuminating device, ground connectors attached to the chassis may be further provided. In this case, the electrodes may be electrically connected to the chassis via the ground connectors. With this configuration, the discharge tubes and the chassis can be connected directly without using lead wiring.

In the aforementioned illuminating device, the ground potential of the chassis and the ground potential of the power supply substrate may be equipotential. With this configuration, the potential is stabilized between the chassis and the power supply substrate. As a result, it becomes easier to light the discharge tubes.

In the aforementioned illuminating device, when the chassis is seen in a plan view, the distance between the two electrodes positioned on the inner side may be smaller than the respective distance between the electrode positioned on the outer side and the electrode positioned on the inner side. This configuration makes it possible to keep the two electrodes positioned on the inner side even closer, so a power supply substrate that is further reduced in size can be realized.

In the aforementioned illuminating device, when the chassis is seen in a plan view, the two electrodes positioned on the inner side may be disposed on a straight line parallel to the short side direction of the chassis. With this configuration, the two electrodes positioned on the inner side can be even closer, so it is possible to realize a power supply substrate that is further reduced in size.

In the aforementioned illuminating device, when the chassis is seen in plan view, the two electrodes positioned on the outer side may be disposed on the aforementioned straight line. With this configuration, it is possible to house the two discharge tubes efficiently inside the chassis by disposing the discharge tubes inside the chassis such that the four electrodes are lined up on the aforementioned straight line.

The technology disclosed in the present specification can also be embodied in a display device including a display panel that performs display by utilizing light from the aforementioned illuminating device. Furthermore, a display device in which this display panel is a liquid crystal panel using a liquid crystal is also novel and useful. Moreover, a television receiver equipped with the aforementioned display device is also novel and useful. With the aforementioned display device and television, it is possible to realize an increase in the surface area of the display region.

### Effects of the Invention

With the technology disclosed in the present specification, in an illuminating device arranged with two discharge tubes which have electrodes at respective end portions of tubular bodies and in which the tubular bodies are bent such that these electrodes are disposed in one direction, it is possible to reduce the manufacturing cost of a power supply substrate connected to the discharge tubes by reducing the size of the power supply substrate.

### BRIEF DESCRIPTION OF THE DRAWINGS

FIG. 1 shows an exploded perspective view of the television receiver TV according to a first embodiment.

FIG. 2 shows a horizontal sectional view of a display device D.

FIG. 3 shows a front view of an illuminating device 2.

FIG. 4 shows a back view of the illuminating device 2.

FIG. 5 shows a perspective view of a discharge tube 20.

FIG. 6 shows a perspective view of a relay connector 14.

FIG. 7 shows a perspective view of a circuit board 6.

FIG. 8 shows an explanatory diagram of a manner in which the circuit board 6 is connected to the relay connectors 14

FIG. 9 shows a front view of the display device D according to a second embodiment.

### DETAILED DESCRIPTION OF EMBODIMENTS

### First Embodiment

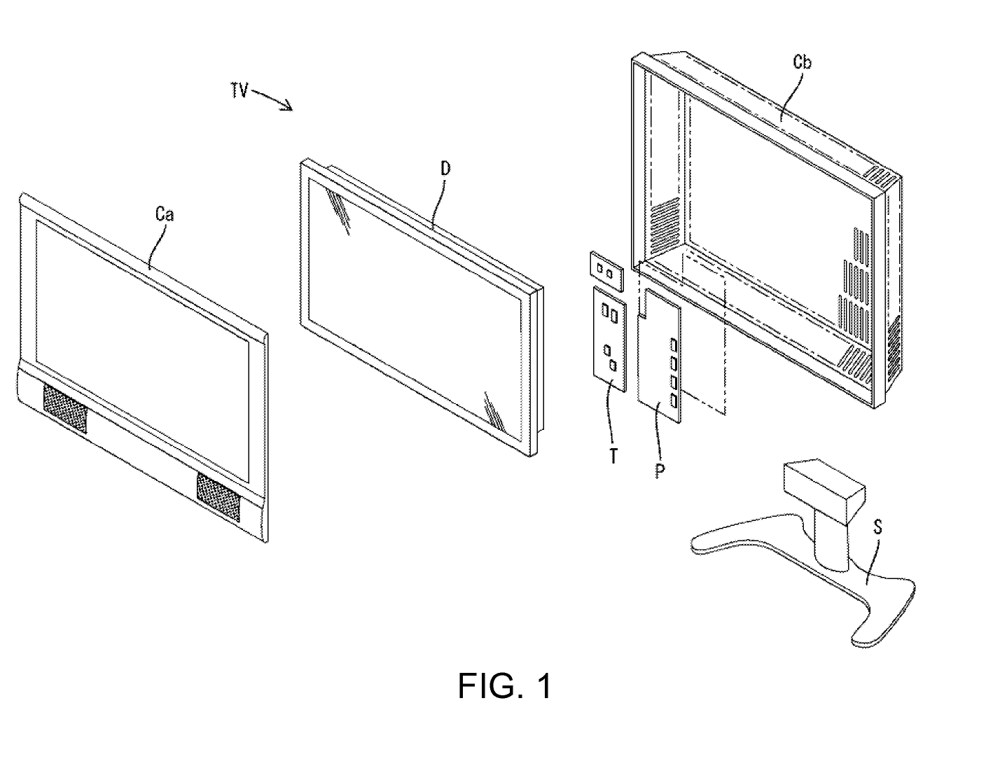

Embodiments will be described with reference to figures. FIG. 1 shows an exploded perspective view of a television receiver TV according to a first embodiment. The television receiver TV includes a display device D, both front and back cabinets Ca and Cb that house this display device D in a sandwiching manner, a power supply P, a tuner T, and a stand S.

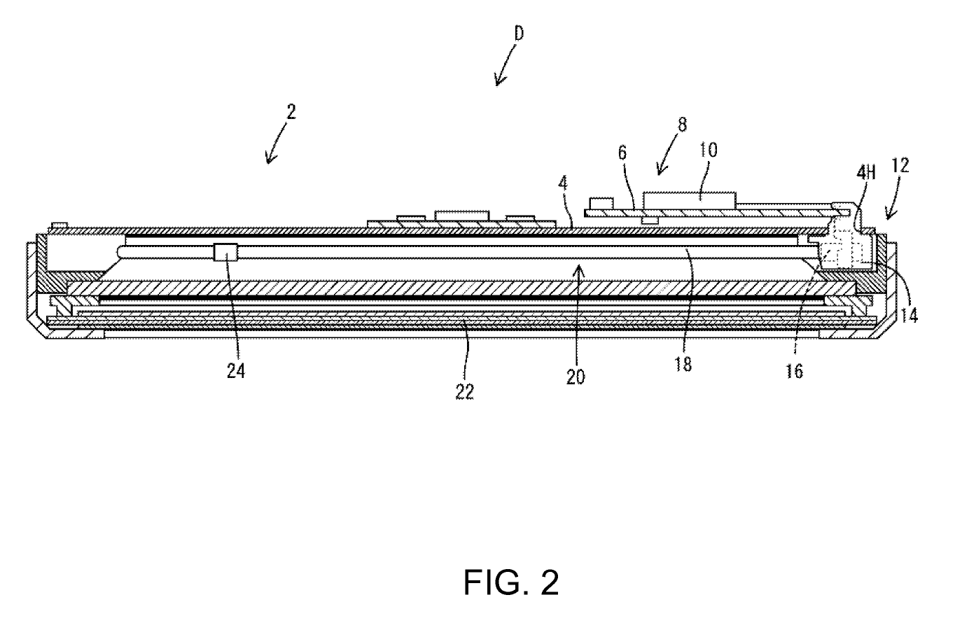

FIG. 2 shows a horizontal sectional view of the display device D. The display device D has a horizontally elongated square shape as a whole, is configured by including a display panel 22 and an illuminating device 2 as shown in FIG. 2, and is a device that is referred to as a so-called liquid crystal display device. The display panel 22 is disposed on the front surface side of the illuminating device 2, and the illuminating device 2 emits light onto the display panel 22 from the back surface side as the backlight. Note that FIG. 2 schematically shows the display device D, and the shapes of relay connectors 14, a power supply substrate 8, and the like will be described in detail with reference to other figures.

Next, the display panel 22 will be described. The display panel is of a known structure in which a liquid crystal is sealed in between a transparent TFT (Thin-Film Transistor) substrate and a transparent CF (Color Filter) substrate. The TFT substrate is provided with TFTs as switching elements connected to mutually perpendicular source wiring lines and gate wiring lines and with pixel electrodes connected to these TFTs. The CF substrate is provided with a common electrode and a color filter in which colored portions of three primary colors of red (R), green (G), and blue (B) are arranged in a matrix.

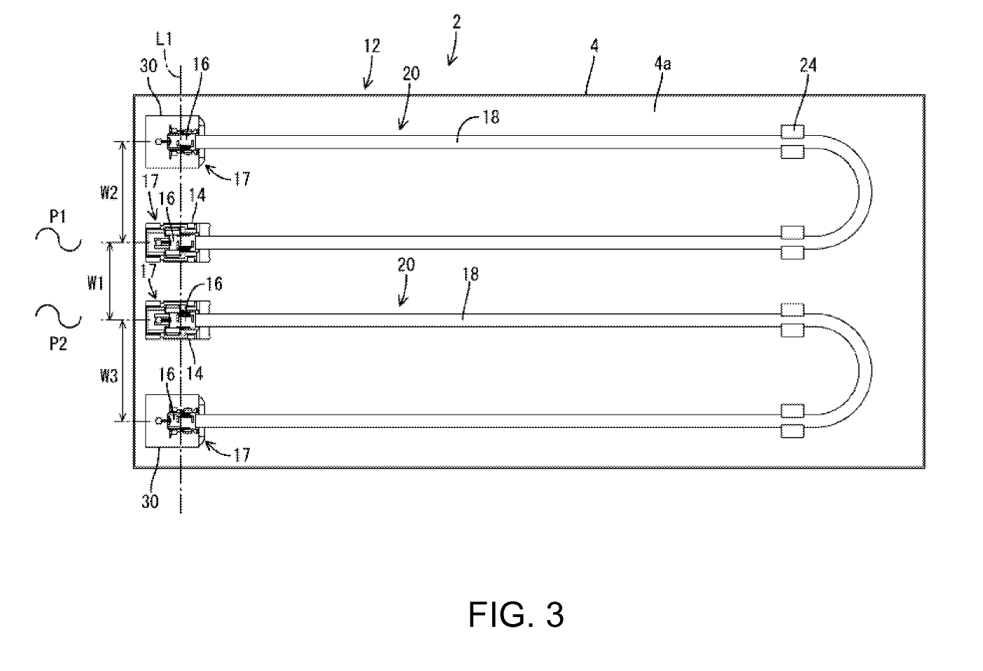

Next, the illuminating device 2 will be described. FIG. 3 shows a front view of the illuminating device 2. As shown in FIG. 3, in the illuminating device 2, a lamp unit 12 includes a chassis 4 made of metal, two discharge tubes 20 having the same length and shape, two relay connectors 14, and two ground terminals 30. The chassis 4 has a horizontally elongated rectangular plate shape as a whole and functions as a lamp housing member. A reflective sheet 4a is disposed on the inner surface side (front surface side) of the chassis 4. The two discharge tubes 20 are disposed on the front surface side of the chassis 4 side by side along the up-down direction (the short side direction of the chassis 4). A plurality of attachment holes 4H (see FIG. 2) having substantially a square shape are formed in positions that overlap with the end portions of the respective discharge tubes 20 so as to pass through this chassis 4 from the front surface to the back surface.

The two relay connectors 14 and the two ground terminals 30 respectively pass through and are attached to the respective attachment holes 4H formed in positions overlapping with the end portions of the discharge tubes 20, and are thereby fixed to the chassis 4. The relay connectors 14 and the ground terminals 30 are disposed vertically along one side edge of the chassis 4 so as to correspond to the end portions of the respective discharge tubes 20 (on a straight line L1 parallel to the short side direction of the chassis 4). In concrete terms, when the chassis 4 is seen in a plan view, the two relay connectors 14 are disposed on the inner side on the straight line L1, while the two ground terminals 30 are disposed on the outer side. At the one side edge of the chassis 4, the discharge tubes 20 are fixed to the chassis 4 by the relay connectors 14 and the ground terminals 30. At the other side edge of the chassis 4, the discharge tubes 20 are fixed to the chassis 4 by lamp clips 24.

The discharge tubes 20 are composed of cold cathode tubes and have electrodes 17 at both end portions of glass tubes 18. The glass tubes 18 are bent in the shape of the letter U such that the electrodes 17 are disposed in one direction. The electrodes 17 are configured of caps 16. The two discharge tubes 20 are housed side by side inside the chassis 4, and the four electrodes 17 are disposed so as to be lined up along the one side edge of the chassis 4 (on the straight line L1 parallel to the short side direction of the chassis 4). When the chassis 4 is seen in a plan view, among the electrodes 17, the two electrodes 17 positioned on the inner side are connected to the relay connectors 14, while the two electrodes 17 positioned on the outer side are connected the ground terminals 30. The chassis 4 is made of metal and grounded, so the electrodes 17 connected to the ground terminals 30 are kept at the ground potential. Alternating-current voltages P1 and P2 of the same phase are applied to the two electrodes 17 positioned on the inner side. Furthermore, the distance W2 between the two electrodes 17 positioned on the inner side is smaller than the respective distances W1 and W3 between the electrode 17 positioned on the outer side and the electrode 17 positioned on the inner side. Note that the detail of the discharge tubes 20 will be described later with reference to another figure.

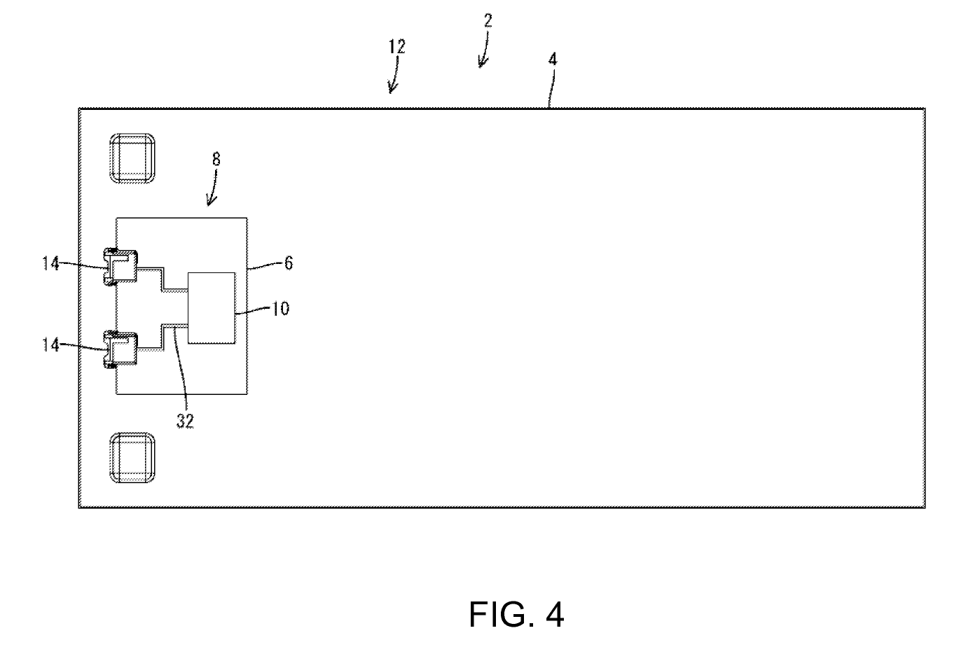

FIG. 4 shows a back view of the illuminating device 2. As shown in FIG. 4, the power supply substrate 8 is disposed on the back surface side of the illuminating device 2. The power supply substrate 8 is disposed between the two electrodes 17 positioned on the outer side (see FIG. 3) when the chassis 4 is seen in a plan view, and the area of the chassis 4 occupied by the power supply substrate 8 is small. The power supply substrate 8 is connected to the chassis 4 and the discharge tubes 20 via the relay connectors 14 and functions as an inverter circuit for supplying power to the discharge tubes 20. Moreover, the power supply substrate 8 is fixed to the chassis 4 via conductive braces (not illustrated), and the ground potential of the chassis 4 and the ground potential of the power supply substrate 8 are kept so as to be equipotential. The power supply substrate 8 has a circuit board 6 and a transformer 10. The transformer 10 is disposed on the back surface of the circuit board 6 and is built into the power supply substrate 8. The transformer 10 is electrically connected to the circuit board 6 and the relay connectors 14 (the two electrodes 17 positioned on the inner side) via circuit wiring lines 32 and adjusts the alternating-current voltages applied to the interior of the discharge tubes 20.

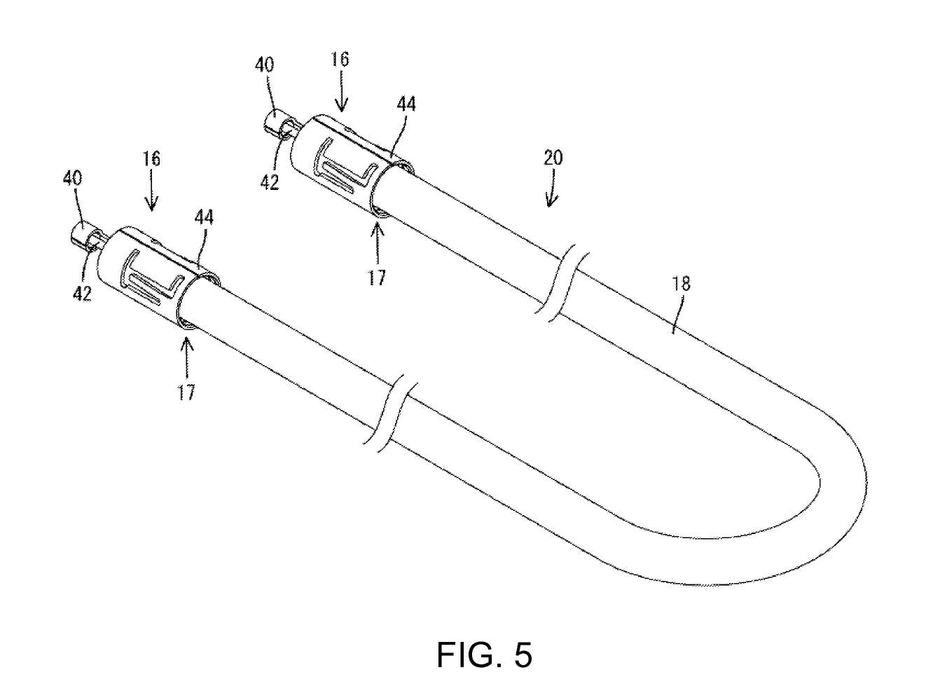

Next, the discharge tubes 20 will be described. FIG. 5 shows a perspective view of a discharge tube 20. As shown in FIG. 5, each discharge tube 20 has outer leads 42 and caps 16. The outer leads 42 are formed so as to protrude from respective end portions of the glass tube 18 and receive the supply of power from the power supply substrate 8. The caps 16 are attached to the outer circumference of the two end portions of the glass tube 18 and each include a main body 44 and a conductive piece 40. The main body 44 is electrically connected to the power supply substrate 8. The conductive piece 40 extends from the main body 44 and is electrically connected to the corresponding outer lead 42. Note that because the discharge tubes 20 are composed of cold cathode tubes, the light adjustment is easier than regular fluorescent tubes.

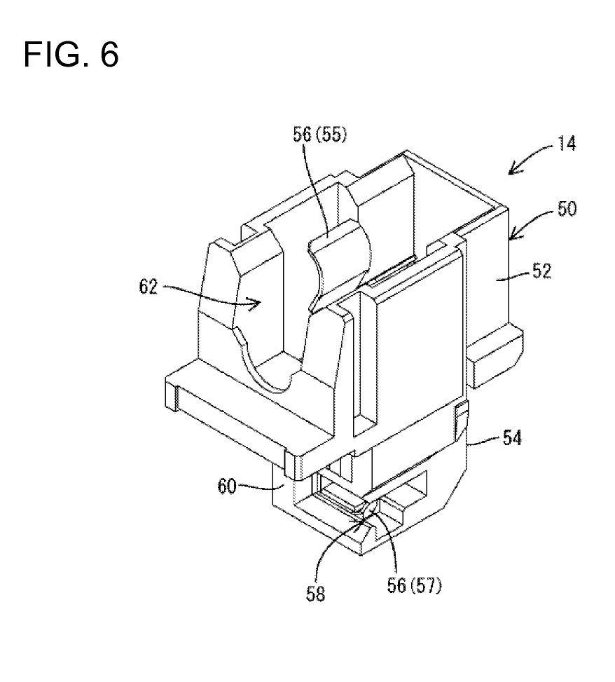

Next, the relay connectors 14 will be described. FIG. 6 shows a perspective view of a relay connector 14. The relay connector 14 can be inserted into an attachment hole 4H provided in the chassis 4 and has a configuration capable of being fixed to this chassis 4. In concrete terms, the relay connector has a holder 50 made of synthetic resin and a relay terminal 56 made of metal, housed inside the holder 50. The holder 50 insulates the relay terminal 56 from the chassis 4 and also realizes the attachment of the relay connector 14 to the chassis 4. In addition, the relay terminal 56 is attached to the holder 50 and is responsible for the electrical connection between the power supply substrate 8 and the corresponding discharge tube 20. Each relay terminal 56 has a discharge tube-side connecting part 55 that establishes the electrical connection with the discharge tube 20 and a power supply substrate-side connecting part 57 that establishes electrical connection with the power supply substrate 8. The power supply substrate-side connecting part 57 has a pair of elastic members (not illustrated) capable of elastically clamping the power supply substrate 8.

The holders 50 are disposed on the front surface side (on the side on which the discharge tubes 20 are formed) of the chassis 4 and are each configured of a box-shaped part (cap housing part) 52 having a block shape as a whole and a protruding part (power supply substrate housing part) 54, which is disposed on the back surface side (on the side on which the power supply substrate 8 is formed) of the chassis 4 and which is configured so as to be capable of insertion into an attachment hole 4H in the chassis 4. A housing compartment 62 that is open in two directions so as to house an end portion of a discharge tube 20 is formed in the box-shaped part 52. The caps 16 formed at the corresponding end portions of the discharge tubes 20 are housed in these housing compartments 62, and when the conductive pieces 40 of the caps 16 and the discharge tube-side connecting parts 55 come into contact and are fixed, the electrical connection between the discharge tubes 20 and the relay connectors 14 is realized.

An insertion opening part 58 that permits the insertion of a portion of the power supply substrate 8 is formed in the protruding part 54. Furthermore, a holder wall part 60 that is formed by bridging across the insertion opening part 58 is formed on the protruding part 54. The holder wall part 60 has a configuration capable of mating with a portion of the power supply substrate 8, i.e., a configuration capable of being fitted in a portion of the power supply substrate 8, and as a result of this mating, the power supply substrate 8 and the holder 50 are positioned, thus realizing the assembly with each other. A manner in which the circuit board 6 is connected to the relay connectors 14 will be described later with reference to other figures.

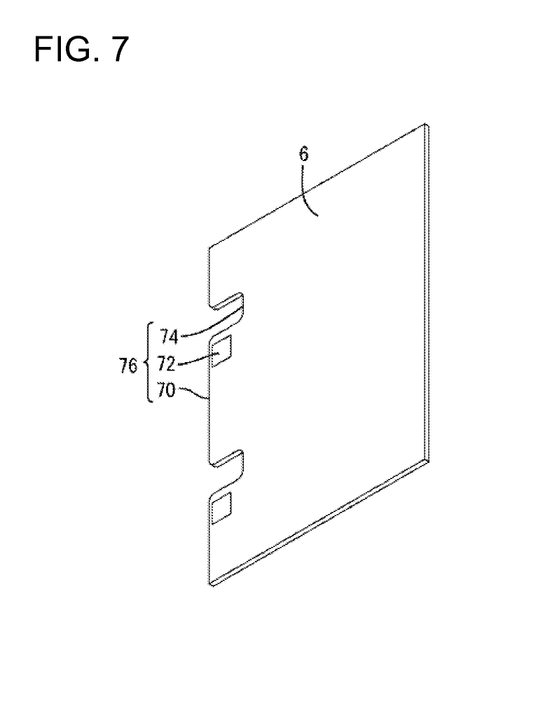

FIG. 7 shows a perspective view of the circuit board 6 configuring the power supply substrate 8. The circuit board 6 has a vertically elongated square shape as a whole and is formed from a paper base material phenol resin copper-clad laminated plate (referred to as paper phenol) as the material. Mating parts 76 that respectively mate with the relay connectors 14 are formed at an end portion of the circuit board 6. Each mating part 76 has a recessed part 74, a projecting part 70, and a conductive part (terminal part) 72 for sending power to the corresponding relay connector 14.

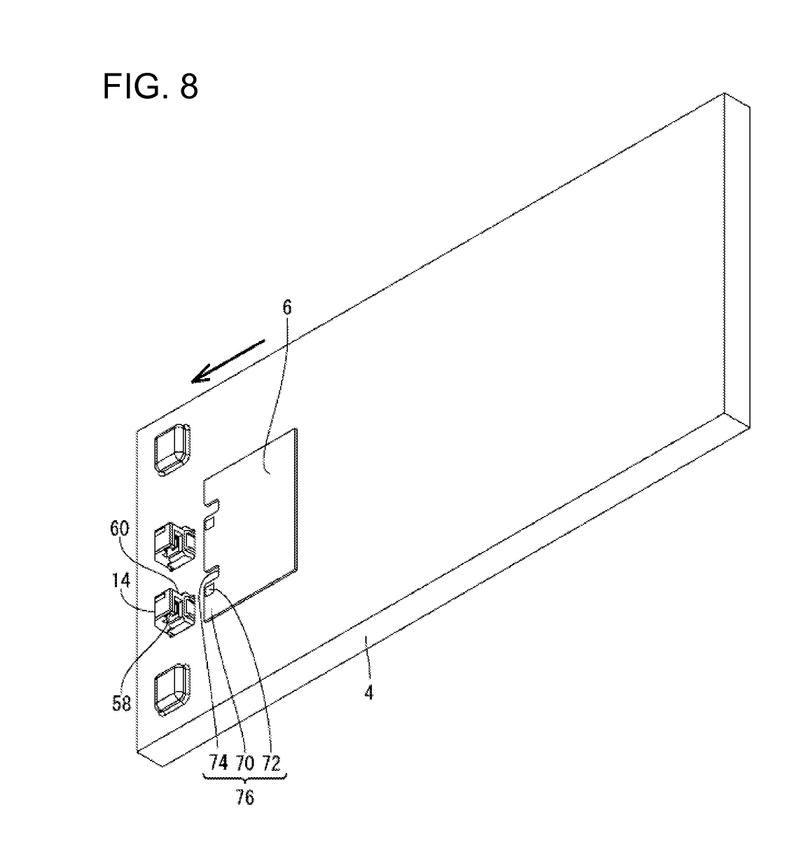

Next, a manner in which this circuit board 6 is assembled to the chassis 4, i.e., a manner in which the circuit board 6 is connected to the relay connectors 14, will be described. FIG. 8 shows an explanatory diagram pertaining to a manner in which the circuit board 6 is connected to the relay connectors 14. First, the projecting parts 70 of the circuit board 6 are inserted into the insertion opening parts 58 formed in the holders 50 of the relay connectors 14 while the circuit board 17 is positioned relative to the relay connectors 14 such that the holder wall parts 60 formed on the holders 50 of the relay connectors 14 and the recessed parts 74 of the circuit board 6 are caused to mate. This realizes the mating between the holder wall parts 60 and the recessed parts 74. Then, the projecting parts 70 of the mating parts 76 are inserted into the insertion opening parts 58 of the relay connectors 14 (holders 50) and clamped by the elastic members formed on the power supply substrate-side connecting parts 57 of the relay terminals 56. Consequently, the electrical connection between the power supply substrate 8 and the relay connectors 14 is ensured.

The television receiver TV of the present embodiment was described in detail. In the illuminating device 2 of the television receiver TV according to the present embodiment, among the four electrodes 17 that are lined up along a side edge of the chassis 4, the two electrodes 17 positioned on the inner side when the chassis 4 is seen in a plan view are used as high voltage-side electrodes connected to the power supply substrate 8, while the two electrodes positioned on the outer side are used as low voltage-side electrodes connected to the ground terminals 30. Therefore, a reduction in the size of the power supply substrate 8 is realized by disposing the power supply substrate 8 only in the vicinity of the two electrodes 17 positioned on the inner side. Consequently, the manufacturing cost of the power supply substrate 8 can be reduced. Moreover, with the illuminating device 2, it is possible to supply power to the two discharge tubes 20 with the single power supply substrate 8.

In addition, in the aforementioned embodiment, the power supply substrate 8 is disposed between the two electrodes 17 positioned on the outer side when the chassis 4 is seen in a plan view. Therefore, the power supply substrate 8 that is further reduced in size than that of conventional illuminating devices is realized.

Furthermore, the single transformer 10 is built into the power supply substrate 8 in the aforementioned embodiment, so when the chassis 4 is seen in a plan view, the two electrodes 17 positioned on the inner side are electrically connected to the transformer 10. Moreover, as a result of the transformer 10 being disposed only in the vicinity of the two electrodes 17 positioned on the inner side, a reduction in the size of the adjustment circuit is realized. This makes it possible to reduce the manufacturing cost of the transformer 10. In addition, it is possible to adjust the voltages of the two discharge tubes 20 with the single transformer 10. Furthermore, the transformer 10 can be manufactured in the same step as the power supply substrate 8, so the manufacturing steps of the illuminating device 2 can be simplified.

Moreover, in the aforementioned embodiment, the alternating-current voltages P1 and P2 of the same phase are applied to the two electrodes 17 positioned on the inner side when the chassis is seen in a plan view. Therefore, reliability of the illuminating device 2 such as voltage resistance is improved.

In addition, in the aforementioned embodiment, as a result of the caps 16 constituting the electrodes 17 being housed in the cap housing parts 62, the discharge tubes 20 are electrically connected to the power supply substrate 8 via the relay connectors 14. Therefore, it is possible to connect the discharge tubes 20 and the power supply substrate 8 directly and simply without using lead wiring.

Furthermore, in the aforementioned embodiment, the power supply substrate 8 has, at an end portion, the mating parts 76 that mate with the insertion opening parts 58, and the mating parts 76 have the recessed parts 74 that sandwich the holder wall parts 60. Therefore, it is possible to realize the card edge-type connection between the relay connectors 14 and the power supply substrate 8 and to simplify the connection between the two.

Moreover, in the aforementioned embodiment, each of the relay connectors 14 includes the insulating holder 50 and the relay terminal 56 attached to the holder 50. Therefore, it is possible to prevent current flowing through the relay connectors 14 from short-circuiting from the relay terminals 56 to the chassis 4 while ensuring the electrical continuity between the power supply substrate 8 and the discharge tubes 20.

In addition, in the aforementioned embodiment, the ground terminals 30 are attached to the chassis 4. Therefore, it is possible to directly connect the discharge tubes 20 and the chassis 4 without using lead wiring and thus to maintain the electrodes 17 of the discharge tubes 20 on the side not connected to the power supply substrate 8 at the ground potential.

Furthermore, in the aforementioned embodiment, the ground potential of the chassis 4 and the ground potential of the power supply substrate 8 are kept at the equipotential by conductive braces. Therefore, the potential is stable between the chassis 4 and the power supply substrate 8, so the discharge tubes 20 can be lit with ease.

Moreover, in the aforementioned embodiment, the distance between the two electrodes 17 positioned on the inner side when the chassis 4 is seen in a plan view is smaller than the respective distance between the electrode 17 positioned on the outer side and the electrode 17 positioned on the inner side. Therefore, a power supply substrate 8 that is further reduced in size than that of conventional illuminating devices is realized.

In addition, in the aforementioned embodiment, all of the electrodes 17 formed at the two end portions of the discharge tubes 20 are disposed on the straight line L1 parallel to the short side direction of the chassis 4 when the chassis 4 is seen in a plan view. Therefore, the two discharge tubes 20 are efficiently housed inside the chassis 4.

### Second Embodiment

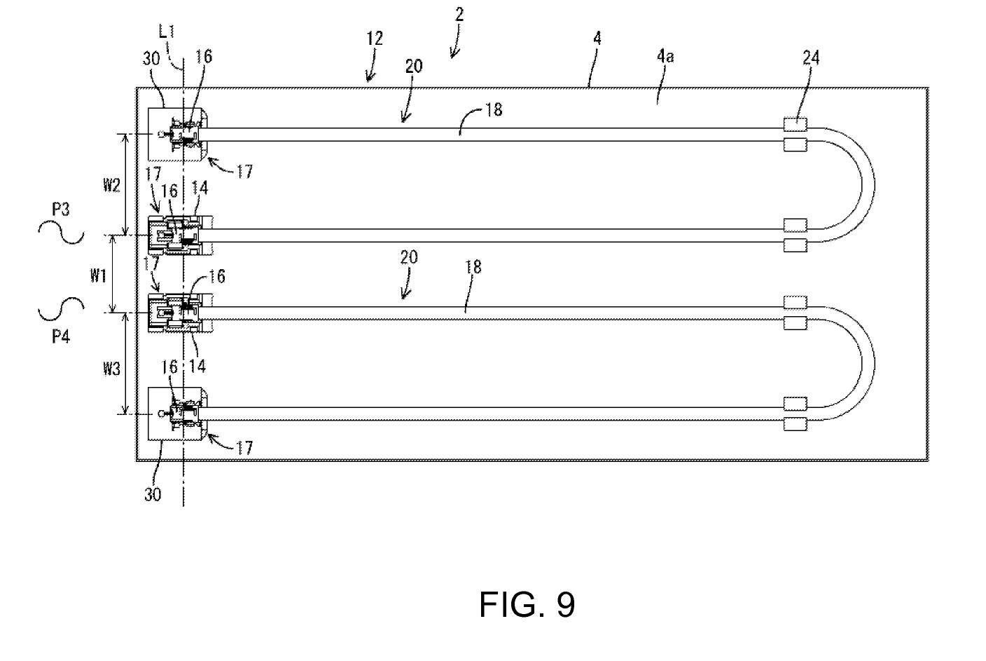

FIG. 9 shows a front view of the illuminating device 2 according to a second embodiment. In the second embodiment, the phase of the alternating-current voltages applied to the two electrodes 17 positioned on the inner side when the chassis 4 is seen in a plan view is different from that of the first embodiment. The remainder of the configuration is the same as that of the aforementioned first embodiment, so the components that are the same are assigned the same reference characters, and the description of the structures, operations, and effects will be omitted.

In the second embodiment, alternating-current voltages P3 and P4 of opposite phases are applied to the two electrodes 17 positioned on the inner side when the chassis 4 is seen in a plan view. Consequently, electromagnetic noise generated in the display panel 22 is cancelled, so the effect of the electromagnetic noise can be suppressed.

The corresponding relationship between the configurations of the embodiments and the configuration of the present invention will be described. The glass tubes 18 are one example of the “tubular bodies.” Furthermore, the transformer 10 is one example of the “adjustment circuit.” Moreover, the ground terminals 30 are one example of the “ground connectors.” In addition, the housing compartments 62 are one example of the “cap housing parts.”

Modified examples of the aforementioned respective embodiments will be enumerated below:

(1) The display panel of the display device device is not limited to a panel in which the switching elements are TFTs, and may also be a panel in which the switching elements are other than TFTs such as MIM (Metal Insulator Metal).

(2) In each of the aforementioned embodiments, cold cathode tubes were shown as an example of the discharge tubes, but besides those, hot cathode tubes, for example, can also be used. Furthermore, it is also possible to use sodium lamps, mercury lamps, metal halide lamps, xenon lamps, and the like as other types of discharge tube.

(3) In each of the aforementioned embodiments, an example was shown in which the shape of the discharge tubes is the shape of the letter U, but the shape of the discharge tubes is not limited. It is sufficient as long as the discharge tubes are bent such that the electrodes are disposed in one direction, and a quasi-U shape, C shape, or the like is also possible.

(4) The electrodes do not have to be lined up on a straight line parallel to the short side direction of the chassis as long as they are disposed in one direction.

(5) Besides the aforementioned respective embodiments, the length dimension, arrangement inside the chassis, and the like of the cold cathode tubes can be modified as appropriate.

(6) In each of the aforementioned embodiments, an example was shown in which the transformer is built into the power supply substrate, but the transformer and the power supply substrate may also be disposed separately on the back surface side of the chassis.

(7) In each of the aforementioned embodiments, cold cathode tubes of a type having caps were shown as an example of the cold cathode tubes, but it is also possible to use cold cathode tubes of a type in which the lead terminals are exposed to the end portions of the glass tubes without having caps, for instance. In this case, the connecting terminals may be omitted from the cold cathode tube holding jigs, and it is sufficient if wiring is connected by soldering or the like directly to the lead terminals of the cold cathode tubes.

(8) The display device is not limited to a liquid crystal display device, and may encompass various types of display device requiring an illuminating device on the back surface side of the display panel are included.

(9) In each of the aforementioned embodiments, a liquid crystal display device using a liquid crystal panel as the display panel was shown as an example, but the present invention can also be applied to display devices using other types of display panel.

(10) In each of the aforementioned embodiments, a television receiver equipped with a tuner was shown as an example, but the present invention can also be applied to display devices not equipped with a tuner.

Thus, embodiments of the present invention were described in detail, but these are merely examples and do not limit the scope of the patent claims. Various changes and modifications of the specific examples described above are included in the technology set forth in the claims.

Moreover, the technological features described in the present specification or drawings exhibit technological utility either alone or in various possible combinations, and are not limited to the combinations set forth in the claims presented at the time of the initial filing of the instant application. In addition, technologies shown as examples in the present specification or drawings make it possible to achieve a plurality of objects at the same time, and achieving one of the objects in itself has technological utility.

### DESCRIPTION OF REFERENCE CHARACTERS

TV television receiver
D display device
2 illuminating device
4 chassis
4H attachment hole
6 circuit board
8 power supply substrate
10 transformer
12 lamp unit
14 relay connector
16 cap
18 glass tube
20 discharge tube
22 display panel
24 lamp clip
30 ground terminal
32 circuit wiring line
34 projecting part
36 conductive part (terminal part)
38 recessed part
39 mating part
40 conductive piece
42 outer lead
44 main body
50 holder
52 box-shaped part
54 protruding part
55 discharge tube-side connecting part
56 relay terminal
57 power supply substrate-side connecting part
58 insertion opening part
60 holder wall part
62 housing compartment
70 projecting part
72 conductive part
74 recessed part
76 mating part

1. An illuminating device comprising:
a chassis;
a discharge tube having electrodes at respective end portions of a tubular body, said tubular body being bent such that said electrodes are disposed in one direction; and
a power supply substrate that supplies power to said discharge tube,
wherein two of said discharge tubes are disposed inside said chassis,
wherein said discharge tubes are housed side by side inside said chassis such that said respective electrodes of said two discharge tubes are lined up in one direction when said chassis is seen in a plan view, and
wherein among said electrodes lined up in one direction, the two electrodes positioned on an inner side are electrically connected to said power supply substrate, while the two electrodes positioned on outer side are electrically connected to said chassis.

2. The illuminating device according to claim 1, wherein said power supply substrate is disposed between said two electrodes positioned on the outer side when said chassis is seen in a plan view.

3. The illuminating device according to claim 1, further comprising an adjustment circuit,
wherein said two electrodes positioned on the inner side are electrically connected to said adjustment circuit.

4. The illuminating device according to claim 3, wherein said adjustment circuit is built into said power supply substrate.

5. The illuminating device according to claim 1, wherein alternating-current voltages of the same phase are applied to said two electrodes positioned on the inner side.

6. The illuminating device according to claim 1, wherein alternating-current voltages of opposite phases are applied to said two electrodes positioned on the inner side.

7. The illuminating device according to claim 1, further comprising relay connectors attached to said chassis,
wherein said electrodes are electrically connected to said power supply substrate via said relay connectors.

8. The illuminating device according to claim 7, wherein
each of said discharge tubes includes:
outer leads protruding from the respective end portions of said tubular body to receive supply of power from said power supply substrate; and
caps each comprising a main body and a conductive piece, the main body being attached to outer circumferences of said tubular body and having a connecting part electrically connected to said power supply substrate, the conductive piece extending from said main body and being connected to the corresponding one of said outer leads,
wherein said caps constitute said electrodes, and said relay connectors have cap housing parts that house said caps.

9. The illuminating device according to claim 7, wherein
said relay connectors each have an insertion opening part that accepts the insertion of said power supply substrate,
said power supply substrate has, at an end portion, mating parts that mate with said insertion opening parts, and
said relay connectors and said power supply substrate are electrically connected.

10. The illuminating device according to claim 9, wherein said mating parts have recessed parts that sandwich said insertion opening parts.

11. The illuminating device according to claim 7, wherein each of said relay connectors comprises an insulating holder attached to said chassis and a relay terminal attached to said folder, the relay terminal being configured to be electrically connected to said power supply substrate and to said discharge tube.

12. The illuminating device according to claim 1, further comprising ground connectors attached to said chassis,
wherein said electrodes are electrically connected to said chassis via said ground connectors.

13. The illuminating device according to claim 1, wherein the ground potential of said chassis and the ground potential of said power supply substrate are equipotential.

14. The illuminating device according to claim 1, wherein when said chassis is seen in a plan view, the distance between said two electrodes positioned on the inner side is smaller than the respective distance between said electrode positioned on the outer side and said electrode positioned on the inner side.

15. The illuminating device according to claim 1, wherein when said chassis is seen in a plan view, said two electrodes positioned on the inner side are disposed on a straight line that is in parallel with a short side direction of said chassis.

16. The illuminating device according to claim 15, wherein when said chassis is seen in a plan view, said two electrodes positioned on the outer side are disposed on said straight line.

17. A display device comprising a display panel that performs display by utilizing light from the illuminating device according to claim 1.

18. The display device according to claim 17, wherein said display panel is a liquid crystal panel using a liquid crystal.

19. A television receiver comprising the display device according to claim 17.
